(19) United States
(12) Patent Application Publication
(10) Pub. No.: US 2024/0334137 A1
(43) Pub. Date: Oct. 3, 2024

(54) Hearing system comprising at least one hearing device

(71) Applicant: SONOVA AG, Staefa (CH)

(72) Inventors: Stefan Raufer, Stäfa (CH); Volker Kühnel, Männedorf (CH); Nadim El Guindi, Zürich (CH); Raoul Glatt, Zürich (CH); Stephan Müller, Uster (CH); Samuel Bucher, Rapperswil (CH); Fernando Javier Balseiro Lago, Zurich (CH)

(21) Appl. No.: 18/414,005

(22) Filed: Jan. 16, 2024

(30) Foreign Application Priority Data
Mar. 27, 2023 (EP) 23164336.2

(51) Int. Cl. H04R 25/00

(52) U.S. Cl. CPC H04R 25/507; H04R 25/43; H04R 25/552; H04R 2225/41

(57) ABSTRACT

A hearing system comprises at least one hearing device having an input unit for obtaining an input audio signal, a processing unit for processing the input audio signal to obtain an output audio signal, and an output unit for outputting the output audio signal. The hearing system further comprises an estimation unit for estimating a signal property of the input audio signal. The processing unit comprises a first audio signal path having a noise cancellation unit for obtaining a target audio signal from the input audio signal, a second audio signal path bypassing the noise cancellation unit and a mixing unit for mixing the target audio signal with audio signals from the second audio signal path for obtaining the output audio signal. The mixing unit is configured to adjust the contribution of the target audio signal to the output audio signal.

### RELATED APPLICATIONS

The present application claims priority to EP Patent Application No. 23164336.2, filed Mar. 27, 2023, the contents of which are hereby incorporated by reference in their entirety.

### BACKGROUND INFORMATION

Hearing systems and audio signal processing thereon are known from the prior art. Audio signal processing may comprise noise cancellation routines for reducing, in particular cancelling, noise from an input signal, thereby improving clarity and intelligibility of a target audio signal contained in the input audio signal. However, the effectiveness and quality of the noise reduction heavily depends on the properties of the input audio signal. In particular, noise cancellation routines are prone to errors and artifacts depending on signal properties of the input signal. In particular at poor signal-to-noise ratios of the input audio signal, noise cancellation routines may suppress the target audio signal, thereby counteracting the purpose of increasing the intelligibility of the target audio signal.

### BRIEF DESCRIPTION OF THE DRAWINGS

Further details, features and advantages of the technology described herein are obtained from the description of exemplary embodiments with reference to the figures, in which:

FIG. 1 shows a schematic depiction of an exemplary hearing system comprising two hearing devices,

FIG. 2 shows a schematic depiction of audio signal processing on one of the hearing devices of the hearing system of FIG. 1,

FIG. 3A exemplarily illustrates a loss of a target audio signal due to noise cancellation as a function of a signal-to-noise ratio of the input audio signal,

FIG. 3B exemplarily illustrates a frequency dependence of the loss in the target audio signal,

FIG. 4 exemplarily illustrates a weighting function for setting a maximum post-filter gain in dependence of an estimated signal-to-noise ratio of the input audio signal, and

FIG. 5 exemplarily illustrates a frequency dependency of the post-filter gain with a given weighting function.

### DETAILED DESCRIPTION

The present technology concerns a hearing system comprising at least one hearing device, in particular at least one hearing aid.

It is an of the present technology to improve audio signal processing on a hearing system, in particular to improve the effectiveness and quality of noise reduction.

This may be achieved by a hearing system as described herein. The hearing system comprises at least one hearing device having an input unit for obtaining an input audio signal, a processing unit for processing the input audio signal to obtain an output audio signal, and an output unit for outputting the output audio signal. The hearing system further comprises an estimation unit for estimating a signal property of the input audio signal. The processing unit of the at least one hearing device comprises a first audio signal path having a noise cancellation unit for obtaining a target audio signal from the input audio signal, a second audio signal path bypassing the noise cancellation unit, and a mixing unit for mixing the target audio signal from the first audio signal path with audio signals from the second audio signal path for obtaining the output audio signal. The mixing unit is configured to adjust the contribution of the target audio signal to the output audio signal based on the estimated signal property of the input audio signal.

The hearing system described herein allows for compensating detrimental effects of the noise reduction on the target audio signal based on signal properties of the input audio signal. Based on the estimated signal property, the contribution of the target audio signal in the output audio signal can be altered, in particular increased or decreased. For example, the contribution of the obtained target audio signal can be increased for input audio signals, for which noise cancellation works well, while in situations. As such, the technology described herein allows to benefit from noise cancellation without detrimental effects on the hearing experience of the user, thereby increasing the sound quality, the speech intelligibility and reducing the listening effort. In situations where noise cancellation produces errors or artifacts, the contribution of the target audio signal may be decreased, allowing the technology described herein to adapt to the specific situation dependent on the expected benefit.

A particular advantage of the technology described herein lies in the fact that the estimated signal property is used for determining a contribution the obtained target audio signal in the output audio signal. The compensation for signal properties of the input audio signal, which may influence the noise cancellation, does not have to be implemented in the noise cancellation unit itself. This avoids complicated solutions in which the noise cancellation unit has to be adapted for different signal properties of the input audio signal, which in particular increases computational effort and latency in the audio signal processing as well as bearing the risk of overfitting the noise cancellation unit. Moreover, the technology described herein increases the flexibility in audio signal processing. For example, different strategies of constructing the output audio signal from the obtained target audio signal and audio signals passed by the noise cancellation unit may be tested without requiring amendments of the noise cancellation unit. This in particular simplifies fitting of the audio signal processing to the demands and preferences of a hearing system user.

The present technology described herein improves quality and accuracy of the noise cancellation perceived by the user. The hearing system of the present technology described herein is, however, not restricted to that use case. Other functionalities of hearing systems, in particular hearing devices, such as signal amplification compensating for hearing loss, may be provided by the hearing system in parallel or sequentially to the noise cancellation functionality described above.

A hearing device in the sense of the present technology described herein is any device for compensating hearing loss, reducing hearing effort, improving speech intelligibility, mitigating the risk of hearing loss or generally processing audio signals, including but not limited to implantable or non-implantable medical hearing devices, hearing aids, over-the-counter (OTC) hearing aids, hearing protection devices, hearing implants such as, for example, cochlear implants, wireless communication systems, headsets, and other hearing accessories, earbuds, earphones, headphones, hearables, personal sound amplifiers, ear pieces, and/or any other professional and/or consumer (i.e. non-medical) audio devices, and/or any type of ear level devices to be used at, in or around the ear and/or to be coupled to the ear.

A hearing system in the sense of the present technology described herein is a system of one or more devices being used by a user, in particular by a hearing impaired user, for enhancing his or her hearing experience. The hearing system comprises the at least one hearing device. Particularly suitable hearing systems may comprise two hearing devices associated with the respective ears of a hearing system user. The hearing system does not require further devices. For example, the hearing system may be entirely realized by the at least one hearing device. In particular, all components of the hearing system may be comprised by the at least one hearing devices. The at least one hearing device, in particular each hearing device, may comprise the estimation unit for estimating a signal property of the input audio signal.

Particularly suitable hearing systems may further comprise one or more peripheral devices. A peripheral device in the sense of the technology described herein is a device of a hearing system, which is not a hearing device, in particular not a hearing aid. In particular, the one or more peripheral devices may comprise a mobile device, in particular a smartwatch, a tablet and/or a smartphone. The peripheral device may be realized by components of the respective mobile device, in particular the respective smartwatch, tablet and/or smartphone. For example, the standard hardware components of a mobile device are used for this purpose by virtue of an applicable piece of hearing system software, for example in the form of an app being installed and executable on the mobile device. Additionally or alternatively, the one or more peripheral devices may comprise a wireless microphone. Wireless microphones are assistive listening devices used by hearing impaired persons to improve understanding of speech in noisy surroundings and over distance. Such wireless microphones include, for example, body-worn microphones or table microphones.

Parts of the hearing system, which are not included in the at least one hearing device may be incorporated in one or more peripheral devices. For example, the estimation unit may be comprised by one or more peripheral devices. In other embodiments, all components of the technology described herein may be realized in the at least one hearing device.

In some examples, a peripheral device may comprise a user interface for presenting information to a user and/or for receiving user inputs. Using a user interface allows for simple and intuitive user interaction.

In some examples, a peripheral device may comprise peripheral device sensors, whose sensor data may be used in the audio signal processing. Suitable sensor data is, for example, position data, e.g. GPS data, movement and/or acceleration data, vital signs and/or user health data. Peripheral device sensors may additionally or alternatively comprise one or more microphones for obtaining audio signals to be used in the hearing system, in particular on the peripheral device.

The at least one hearing device and possibly one or more peripheral devices may further be connectable to one or more remote devices, in particular to one or more remote servers. The term “remote device” is to be understood as any device which is not part of the hearing system. In particular, the remote device is positioned at a different location than the hearing system. A connection to a remote device, in particular a remote server, allows to include remote devices and/or services provided thereby in the audio signal processing.

Different devices of the hearing system, in particular the at least one hearing device and/or at least one peripheral device, may be connectable in a data transmitting manner, in particular via wireless data connection. A wireless data connection may also be referred to as wireless link or, in short, “WL” link. The wireless data connection can be provided by a global wireless data connection network to which the components of the hearing system can connect or can be provided by a local wireless data connection network, which is established within the scope of the hearing system. The local wireless data connection network can be connected to a global data connection network, such as the internet, e.g. via landline or it can be entirely independent. A suitable wireless data connection may be by Bluetooth, Bluetooth LE audio or similar protocols, such as, for example, Asha Bluetooth. Further exemplary wireless data connections are DM (digital modulation) transmitters, aptX LL and/or induction transmitters (NFMI). Also other wireless data connection technologies, for example broadband cellular networks, in particular 5G broadband cellular networks, and/or WiFi wireless network protocols, can be used.

In the present context, an audio signal, in particular an audio signal in form of the input audio signal and/or the output audio signal, may be any electrical signal, which carries acoustic information. In particular, an audio signal may comprise unprocessed or raw audio data, for example raw audio recordings or raw audio wave forms, and/or processed audio data, for example a beamformed audio signal, constructed audio features, compressed audio data, a spectrum, in particular a frequency spectrum, a cepstrum and/or cepstral coefficients and/or otherwise modified audio data. The audio signal can particularly be a signal representative of sound detected locally at the user's position, e.g. generated by one or more electroacoustic transducers in the form of one or more microphones. An audio signal may be in the form of an audio stream, in particular a continuous audio stream. For example, the input unit may obtain the input audio signal by receiving an audio stream provided to the input unit. For example, an input audio signal received by the input unit may be an unprocessed recording of ambient sound, e.g. in the form of an audio stream received wirelessly from a peripheral device and/or a remote device, which may detect said sound at a position distant from the user, in particular from the user's ears. The audio signals in the context of the technology described herein can also have different characteristics, format and purposes. In particular, different kinds of audio signals, e.g. the input audio signal and/or the output audio signal, may differ in characteristics and/or format.

An audio signal path in the sense of the present technology described herein is a signal path in which an audio signal is forwarded and/or processed during the audio signal processing. An audio signal path is a signal path which receives an audio signal from upstream signal paths and/or processing units and provides the audio signal to downstream signal paths and/or processing units.

An input unit in the present context is configured to obtain the input audio signal. Obtaining the input audio signal may comprise receiving an input signal by the input unit. For example, the input audio signal may correspond to an input signal received by the input unit. The input unit may, for example, be an interface for incoming input signals. For example, an incoming input signal may be an audio signal, in particular in form of an audio stream. The input unit may be configured for receiving an audio stream. For example, the audio stream may be provided by another hearing device, a peripheral device and/or a remote device. The input signal may already have the format of the input audio signal. The input unit may also be configured to convert an incoming input signal, in particular an incoming audio stream, into the input audio signal, e.g. by changing its format and/or by transformation. Obtaining the input audio signal may further comprise to provide, in particular to generate, the input audio signal based on the received input signal. For example, the received input signal can be an acoustic signal, i.e. a sound, which is converted into the input audio signal. For this purpose, the input unit may be formed by or comprise one or more electroacoustic transducers, e.g. one or more microphones. In some examples, the input unit may comprise two or more microphones, e.g. a front microphone and a rear microphone.

The input unit may further comprise processing hardware and/or routines for (pre-)processing the input audio signal. For example, the input unit may comprise a beamformer, in particular a monaural or binaural beamformer, for providing a beamformed input audio signal.

An output unit in the present context is configured to output the output audio signal. For example, the output unit may transfer or stream the output audio signal to another device, e.g. a peripheral device and/or a remote device. Outputting the output audio signal may comprise providing, in particular generating, an output signal based on the output audio signal. The output signal can be outputted as sound based on the output audio signal. In this case, the audio output unit may be formed by or comprise one or more electroacoustic transducers, in particular one or more speakers and/or so-called receivers. The output signal may also be an audio signal, e.g. in the form of an output audio stream and/or in the form of an electric output signal. The electric output signal may, for example, be used to drive an electrode of an implant for, e.g. directly stimulating neural pathways or nerves related to the hearing of a user.

The processing unit in the present context may comprise a computing unit. The computing unit may comprise a general processor, adopted for performing arbitrary operations, e.g. a central processing unit (CPU). The processing unit may additionally or alternatively comprise a processor specialized on the execution of a neural network, in particular a deep neural network. In some examples, a processing device may comprise an AI chip for executing a neural network. However, a dedicated AI chip is not necessary for the execution of a neural network. Additionally or alternatively, the compute unit may comprise a multipurpose processor, an application-specific integrated circuit (ASIC), a field programmable gate array (FPGA), a digital signal processor (DSP), in particular being optimized for audio signal processing, and/or a multipurpose processor (MPP). The processing unit may be configured to execute one or more audio processing routines stored on a data storage, in particular stored on a data storage of the respective hearing device.

The processing unit may further comprise a data storage, in particular in form of a computer-readable medium. The computer-readable medium may be a non-transitory computer-readable medium, in particular a data memory. Exemplary data memories include, but are not limited to, dynamic random access memories (DRAM), static random access memories (SRAM), random access memories (RAM), solid state drives (SSD), hard drives and/or flash drives.

The noise cancellation unit serves for obtaining, in particular separating, the target audio signal from the input audio signal. In the present context, a target audio signal is in particular to be understood as any audio signal carrying acoustic information on sounds having relevance to the user, e.g. speech of one or more conversation partners, speech signals of other relevance to the user, e.g. announcements and/or other spoken information like news, music, warning signals, and the like. The target audio signal and the corresponding sounds may vary according to the instant situation, in particular the instant acoustic scene. In realistic use cases, relevant sounds for the user are intermixed with or superimposed by noise. For example, noise can stem from various acoustic sources in a room, or ambient sound as e.g. traffic noise and the like. Noise cancellation serves to reduce or remove the noise from the input audio signal to provide a better understandable and clearer target audio signal. In this sense, the obtained target audio signal is the result of a noise reduction, in particular noise cancellation, routine applied to the input audio signal. The obtained target audio signal is a representation of target sounds relevant for the user containing a reduced amount of noise, in particular containing no perceptually relevant noise. The quality of the obtained target audio signal depends on the noise cancellation routine and/or signal properties of the input audio signal. For example, at poor signal-to-noise ratios, noise cancellation routines may lead to artifacts and/or loss in the target audio signal.

The audio input signal path including the noise cancelling unit is referred to as the first audio signal path in the present terminology. The second audio signal path bypasses the noise cancellation unit. The audio signals provided by the second audio signal path to the mixing unit have hence not undergone noise reduction, in particular noise cancellation, routines. The audio signals provided by the second audio signal path are not subjected to possible detrimental effects of or alterations by the noise cancellation. In some examples, the second audio signal path forms a bypass for the input audio signal and, thus, provides the input audio signal to the mixing unit.

The estimation unit is configured for estimating a signal property of the input audio signal. The estimation unit may estimate one or more signal properties of the input audio signal. For estimating the signal property, the estimation unit may receive the input audio signal or an audio signal and/or electrical signal comprising relevant information on the input audio signal. For example, the input audio signal may be provided to the estimation unit for estimating the signal property. It is also possible, that a different type of audio signal, in particular a more or less processed input audio signal may be provided to the estimation unit.

The estimation unit may be comprised by the hearing device and/or by a peripheral device. For estimating the audio signal property on a peripheral device, the input audio signal from the hearing device may be provided to the peripheral device, e.g. by a wireless data connection. It is also possible that the peripheral device obtains a separate peripheral input audio signal for estimating a signal property of the input audio signal. While the peripheral input audio signal may differ from the input audio signal, e.g. because the peripheral device is worn or carried at a different position, the peripheral input audio signal may still contain sufficient information for estimating relevant signal properties, e.g. a signal-to-noise ratio and/or sound levels of the input audio signal.

In some examples, the estimation unit may operate with an input audio signal of the hearing device itself. This allows for a more precise estimation of the relevant signal property. In particular, specific hardware and/or processing features of the input device may be taken into account. For example, characteristics of one or more electroacoustic transducers of the input unit of the hearing device may lead to specific noise level, which would not be present in a peripheral input audio signal.

The mixing unit may set mixing levels of the target audio signal and audio signals from the second audio signal path, in particular the input audio signal. The mixing unit may additionally or alternatively apply a target gain to the target audio signal to obtain a weighted target audio signal. The mixing unit may further or alternatively apply an input gain to audio signals of the second audio signal path, in particular to the input audio signal, for obtaining a weighted input audio signal. The term “input gain” refers to gains applied to audio signals within the second signal path. The input gain is, thus, applied to audio signals, which bypass the noise cancellation unit via the second signal path. The mixing unit may set a mixing ratio of the weighted target audio signal and a weighted input audio signal. A mixing ratio of the target audio signal and audio signals from the second audio signal may additionally or alternatively be determined by the respective input gain and/or target gain.

In some examples, the target gain may comprise different components. For example, the target gain may comprise gain components depending on the estimated signal property of the input audio signal. For instance, the gain components may comprise a post-filter gain, in particular a frequency dependent post-filter gain. The post-filter gain may for example directly dependent on the estimated signal property and/or may indirectly depend on the estimated signal strength, e.g. by being modulated based on a weighting function, which depends on the estimated signal property. An exemplary target gain may comprise only a post-filter gain, in particular a modulated post-filter gain.

The target gain may additionally or alternatively comprise gain components, which do not depend on the estimated signal property. In particular, the target gain may comprise gain components depending on external parameters, in particular user-specific data, such as user preferences and/or user inputs. For example, the target gain may comprise a gain component representing a noise cancellation strength, in particular a user-set noise cancellation strength.

In some examples, the target gain may comprise a post-filter gain, directly or indirectly depending on the estimated signal property, and gain components based on an externally set noise cancellation strength, in particular a user-set noise cancellation strength. For example, a noise cancellation strength, in particular a user-set noise cancellation strength, may set a general perceptive contribution of the target audio signal to the output audio signal. The post-filter gain may further adjust the contribution of the target audio signal to compensate for influences of signal properties of the input audio signal, in particular for artifacts of the noise cancelling unit depending on the signal properties, on the obtained target audio signal. This way the perceived contribution of the target audio signal corresponds to the set noise cancellation strength, in particular the user-set noise cancellation strength, independently of signal properties of the input audio signal.

The input gain may comprise gain components depending on the estimated signal property and/or gain components not depending on the estimated signal property. In some examples, the input gain only comprises gain components not depending on the estimated signal property. For example, the input gain may comprise, in particular consist of, gain components based on external parameters, in particular representing a noise cancellation strength, e.g., a user-set noise cancellation strength.

Different gain components of the target gain and/or the input gain may be applied concurrently and/or sequentially. For example, different gain components may be multiplied with each other to obtain the gain, which is applied to the respective audio signal. For example, a post-filter gain and one or more further gain components, in particular a gain component representing a noise cancellation strength, may be multiplied to obtain the target gain. Alternatively, a post-filter gain and one or more further gain components of the target gain may be sequentially applied to the target audio signal to obtain the weighted target audio signal.

In some examples, the noise cancellation unit comprises a neural network for contributing to obtaining the target audio signal. In some examples, the neural network may obtain the target audio signal from the input audio signal. For example, the noise cancellation unit may be realized by the neural network. The neural network of the noise cancellation unit may in particular be a deep neural network.

Neural networks, in particular deep neural networks, have proven to be particularly suitable for high quality noise cancellation. Like other noise cancellation routines, neural network noise cancellation may be influenced by signal properties of the input audio signal. In particular, neural networks may be particularly prone to overfitting and/or producing artifacts in dependence of the signal properties of the input audio signal. As such, the technology described herein is particularly advantageous for noise cancellation using at least one neural network. Possible detrimental effects of the neural network processing can be flexibly addressed without interfering with the neural network processing itself. Since neural networks are far more compute and data intensive than other processing routines, addressing the influence of signal properties of the input audio signal within the neural network would be heavily limited by computing resources provided by hearing device. Moreover, reliable neural network processing requires intensive training procedures using huge training data sets. Hence, trying to address influences of signal properties of the input audio signal in the neural network may lead to overfitting and requiring time- and cost-intensive re-training of the neural network. The technology described herein allows for decoupling the actual noise cancellation from compensating for signal properties of the input signal, resulting in greater flexibility. In particular, different processing strategies, in particular different contributions of the obtained target audio signal to the output audio signal, may be tested without requiring intensive retraining of the neural network.

In some examples, the estimation unit is comprised by the at least one hearing device, in particular by the processing unit thereof. In particular, each hearing device of the hearing system comprises an estimation unit. This has the advantage that the at least one hearing device may be used as a standalone unit, profiting of the advantages of the technology described herein, without requiring the user to carry further peripheral devices. In particular, it is possible that the hearing system only comprises the at least one hearing device, in particular two hearing devices associated with the respective ears of a hearing system user.

In some examples, the estimation unit is comprised by the noise cancellation unit, in particular by a neural network thereof. This allows for a particularly easy and resource-efficient integration of the estimation unit in the at least one hearing device. For example, the estimation unit may estimate a signal-to-noise ratio or a sound level, e.g. a noise floor estimate, of the input audio signal. This can, for example, be achieved by comparing the input audio signal provided to the noise cancellation unit with the obtained target audio signal. The technology described herein is particularly suitable for integrating the estimation unit into the noise cancellation unit, because the respective information is only needed at a later stage for determining the composition of the output audio signal. Less advantageous solutions, which may for example require to adapt the noise cancellation unit depending on the signal property of the input audio signal, would require a separate upstream estimation unit.

In other embodiments, the estimation unit may be separate from the noise cancellation unit. A separate noise cancellation unit has the advantage that the estimated signal property can be used at different stages of the audio signal processing, e.g. for steering the audio signal processing. For example, based on the obtained signal property of the input audio signal, it can be decided whether noise cancellation is required at all.

In some examples, the estimation unit is configured for determining at least one of the following signal properties of the input audio signal: a signal-to-noise ratio (SNR), a sound level and/or a target direction of a sound source. These signal properties have been proven to have a significant impact on the noise cancellation performance.

The SNR is particularly relevant for the noise cancellation. The effectiveness and quality of noise cancellation routines, independently of being implemented by a neural network or other routines, may strongly depend on the SNR. At high or good SNR (i.e. the target audio signal is dominant in the input audio signal), the noise cancellation is obtainable with high quality and effectiveness, but also less relevant for improving the hearing experience of a user. At low or poor SNR (i.e. the noise has a relevant contribution to the input audio signal or even dominates the input audio signal), noise cancellation is of particular relevance for the hearing experience of the user. However, noise cancellation routines have shown to suppress the target audio signal at poor SNR. In particular, a strength of the obtained target audio signal decreases with decreasing SNR. Good SNR may, for example, be characterized by positive decibel values (SNR>0 dB). Poor SNR may, for example, be characterized by negative decibel values (SNR<0 dB). In general, the definition of good and poor SNR may depend on the instant acoustic scene, in particular on high or low sound pressure levels of the instant acoustic scene, the frequency spectrum of the noise and target signal, and/or the degree of hearing loss.

The term “sound level” is in particular to be understood as an estimation of one or more statistical properties of an audio signal, in the present case the input audio signal. The sound level may comprise one or more approximations of a statistical property in the audio signal. The sound level may be a scalar quantity or vector-valued. For example, a vector-valued sound level may comprise an approximation of a statistical property with frequency resolution. The sound level may also be referred to as input level estimate. For example, the sound level may be determined by filtering a mean value, in particular a root-mean-square (RMS) value, of audio signals. Filtering may advantageously comprise different processing techniques, in particular different combinations of linear filters, non-linear averages, threshold-based signal detection and/or decision logic. Particularly suitable level features may comprise a sound pressure level (SPL), in particular frequency weightings of the SPL, e.g. an A-weighting of the SPL, a noise floor estimate (NFE) and/or a low-frequency level (LFL). The SPL, frequency weightings of the SPL, and/or the NFE are particularly relevant. For example, the NFL may be used as good approximation of the SNR, but may be estimated with less computational effort.

A target direction of a sound source is a direction in which a sound source is placed in respect to a hearing system user, in particular with respect to the at least one hearing device. The target direction of the sound source is in particular relevant for binaural audio signal processing. For example, a sound source may be placed to a side of the user so that the sound source is closer to one ear of the user than to the other In that regard, target sounds of that sound source, which are represented in target audio signal, should be stronger, in particular louder, in the ear nearer to the sound source. Using the target direction of a sound source, the contribution of the target audio signal to the output audio signal may be steered to reflect the natural hearing sensation of directionality with respect to the sound source. When two hearing devices are used, in particular for binaural audio processing, the contribution of the target audio signal in the respective output audio signal may be synchronized, so that spatial information on the position of the sound source is maintained.

In some examples, the estimation unit is configured for determining a frequency dependence of the signal property, in particular of the SNR. The influence of the signal property of the input audio signal on the noise cancellation may frequency dependent. For example, the loss in the obtained target audio signal may be particularly pronounced for higher frequencies. As such, the frequency dependence of the signal property, in particular the SNR, contains valuable information for steering the audio signal processing, in particular for determining the contribution of the obtained target audio signal to the output audio signal. In some examples, the adaptation of the contribution of the obtained target audio signal in the output audio signal may be frequency dependent. For example, the contribution of the obtained target audio signal may be adapted independently in a plurality of frequency bands.

In some examples, the estimation unit is configured for averaging the estimated signal property over a predetermined time span. Averaging the estimated signal property prevents volatile changes of the contribution of the target audio signal in the output audio signal, which may cause irritation for the user. Averaging allows for a smooth adaption of the composition of the output audio signal. In some examples, a post-filter gain, in particular a maximum post-filter gain, may be smoothly adapted based on the averaged signal property. For example, the post-filter gain, in particular one or more pre-defined post-filter gains, may be modulated by a weighting function, which depends on the averaged signal property.

In some examples, the estimation unit is configured for averaging the estimated signal property over a time span of a few seconds, e.g. a time span reaching from 1 s to 60 s, in particular 1 s to 30 s, in particular 2 s to 10 s, e.g. about 5 s. The time span may be adapted to the instant input audio signal, in particular one or more of its signal properties.

In some examples, the mixing unit is configured for applying a post-filter gain, in particular a frequency dependent post-filter gain, to the target audio signal, wherein the post-filter gain depends on the estimated signal property. In particular, the strength and/or frequency dependence of the post-filter gain can depend on the estimated signal property. For example, an offset of the post-filter gain, in particular a spectrally-shaped offset of the post-filter gain, can be set in dependence of the estimated signal property. The post-filter gain may contribute to a target gain applied to the target audio signal by the mixing unit. The post-filter gain may directly depend on the estimated signal property. For example, a specific post-filter gain may be selected from a plurality of different pre-defined post-filter gains based on the estimated signal property. Different post-filter gains may be associated with different signal properties of the input audio signal, in particular is different types of input audio signals. Additionally or alternatively, the post-filter gain may indirectly depend on the estimated signal property. For example, a post-filter gain, in particular one or more pre-defined post-filter gains, may be modulated by weighting function, which depends on the estimated signal property.

In some examples, the post-filter gain, in particular one or more pre-defined post-filter gains and one or more weighting functions, may be adapted to the noise cancellation routine applied by the noise cancellation unit, in particular a neural network comprised thereby. In some examples, the post-filter gain may depend on the type of noise cancellation applied by the noise cancellation unit. As such, the post-filter gain may be optimally adapted to specific properties of the respective type of noise cancellation. In particular, a change in the noise cancellation routine may be combined with an update or change of the post-filter gain. For example, the post-filter gain may be adapted based on a retraining of the neural network for noise cancellation.

In some examples, the post-filter gain only depends on the type of noise cancellation applied by the noise cancellation unit, while the weighting function only depends on the signal property of the input audio signal. For example, the post-filter gain may be predefined based on the specific type of noise cancellation applied. As such, the post-filter gain may be chosen static, while a dynamic adaption is achieved via the weighting function. The resulting target gain is optimally adapted to properties of the type of noise cancellation as well as signal properties of the input audio signal.

It is also possible that the post-filter gain and the weighting function depend on one or more signal properties of the input audio signal. For example, the post-filter gain and the weighting function may depend on the same signal property of the input audio signal. In some examples, the post-filter gain and the weighting function may depend on different signal properties of the input audio signal. This way, a particularly flexible adaption of the target gain may be achieved by taking into account the respective signal properties, on which the post-filter gain and the weighting function depend.

The technology described herein advantageously allows for an adaptive post-filter gain. The adaptive post-filter gain may compensate for influences of the estimated signal property on the noise cancellation, in particular on the obtained target audio signal. For example, a loss in the obtained target audio signal based on the signal property of the input audio signal, in particular on SNR of the input audio signal, can be compensated by accordingly setting the strength of the post-filter gain. For example, the post-filter gain may be adapted by a weighting function, which depends on the estimated signal property.

In some examples, the post-filter gain is frequency dependent. This allows for compensating for a frequency dependence of influences on the noise cancellation and/or the obtained target audio signal.

In some examples, the mixing unit is configured to adapt the post-filter gain independently in a plurality of frequency bands. This increases the flexibility of the post-filter gain. In particular, frequency-dependent effects of the signal property of the input audio signal may be addressed. For example, the post-filter gain may independently be adapted in two or more frequency bands. It is also possible to adjust the frequency bands, in particular the width and the position of the frequency bands within the frequency spectrum. For example, cut-off frequency dividing two frequency bands may be shifted.

In some examples, the mixing unit is configured for adding a spectrally-shaped gain offset to the post-filter gain, in particular by modulating the post-filter gain with a weighting function being frequency dependent. For example, the mixing unit may be configured to amend the frequency dependence of the post-filter gain. Different post-filter gains may be chosen in dependence of the estimated signal property, in particular the frequency dependence thereof.

In some examples, the mixing unit is configured to adapt an output signal strength of the target audio signal in the output audio signal to be equal or higher than an input signal strength of the target audio signal in the input audio signal. Advantageously, the technology described herein allows to adapt the output signal strength of the target audio signal to match the corresponding input signal strength of the target audio signal in the input audio signal, thereby ensuring a natural hearing experience of the sounds represented in the target audio signal. The output signal strength of the target audio signal may even be increased above its input signal strength, thereby facilitating perception and intelligibility of the sounds represented in the target audio signal, in particular for hearing impaired hearing system users.

Signal strength is in particular to be understood as a measure representing a sound energy of corresponding sounds. In some examples, the output signal strength of the target audio signal is adapted frequency-dependently. In some examples, the adapted signal strength may be a frequency-dependent energy of the target audio signal. For example, the output frequency-dependent energy of the target audio signal is adapted to match or exceed the input frequency-dependent energy of the target audio signal in the input audio signal.

In some embodiments, the sound pressure level (SPL) may be a suitable measure of the signal strength. For example, the SPL of the target audio signal is adapted to match or exceed the SPL of the target audio signal in the input audio signal.

In some examples, the mixing unit allows to modify the obtained target audio signal independent of further audio signals contained in the input audio signal. For example, the mixing unit may apply an adaptive post-filter gain exclusively to the obtained target audio signal. This allows for a high flexibility in steering the composition of the output audio signal. In some examples, the obtained target audio signal may be enhanced to satisfy the preferences or needs of the respective user.

In some examples, the mixing unit is configured for further adjusting the contribution of the target audio signal to the output audio signal, in particular a mixing ratio between the target audio signal and an audio signal of the second audio signal path, based on user-specific data. This allows to consider user-specific data to adapt, in particular personalize, the hearing experience for the individual user. User-specific data may in particular comprise user preferences and/or user inputs and/or a position of the user and/or an activity of the user. For example, user preferences may be incorporated by fitting the audio signal processing, in particular the strength and contribution of the noise cancellation and/or the obtained target audio signal. Such fitting may in particular be provided by hearing care professionals and/or inputs by the user.

For example, adjusting the contribution of the target audio signal based on user-specific data may comprise providing a gain component representing the user-specific data as part of the target gain. The gain component may in particular represent a user-specific noise cancellation strength, in particular a user-set noise cancellation strength.

User inputs may contain commands and/or information provided by the user for amending the audio signal processing in a specific instance. For example, the user may input respective commands using a user interface, in particular a user interface of a peripheral device of the hearing system, e.g. a smartphone. For example, the user may choose the strength of the contribution of the target audio signal to the output audio signal and thereby the strength of the perceived noise cancellation by using respective inputs. For example, a hearing system software may provide a selection to the user for changing the strength of the noise cancellation, e.g. in form of a slider and/or other kinds of selection possibilities.

A position of the user and/or an activity of the user may in particular be provided by respective sensors, for example by peripheral device sensors of a peripheral device of the hearing system. A position of the user may for example be provided by respective GPS data. An activity of the user may be estimated by acceleration sensors and vital signs, e.g. a heartrate of the user. This way, different activities and positions of the user may be considered in steering the audio signal processing, in particular in adjusting the contribution of the target audio signal to the output audio signal. For example, when the user is sitting in a restaurant, a high noise cancellation may be advantageous to improve intelligibility of conversation partners. If the user is moving, e.g. doing sports, the noise cancellation may be less relevant for the user. In contrast, a too strong reduction of the noise may lead to loss of relevant acoustic information to the user, such as traffic noise and the like.

In some examples, the mixing unit is configured to adjust the contribution of the target audio signal in the output audio signal in perceptually equidistant steps. Adjusting the contribution of the target audio signal in perceptually equidistant steps in particular means that, for several steps, in particular for all steps, on a discrete user control, the perceived effect of noise reduction is the same between these steps, e.g., between all steps. This increases the hearing experience of the user and allows for intuitive handling of the hearing system.

In some examples, the second audio signal path provides the input audio signal to the mixing unit. This allows for a particular resource efficient audio signal processing. The input audio signal has not to be processed in the second audio signal path. Moreover, this ensures that no relevant information contained in the input audio signal, in particular in noise or the target audio signal contained therein, is lost or otherwise amended upon the audio signal processing.

In some examples, the second audio signal path comprises a delay compensation unit for compensating processing times in the first audio signal path, in particular processing times by the noise cancellation unit. This is in particular advantageous when combining the obtained target audio signal with the unprocessed input audio signal. The audio signals to be combined are synchronized, avoiding disturbing echoing effects and ensuring more accurate, and therewith higher quality, noise cancelling.

In some examples, the hearing system comprises two hearing devices adapted for binaural audio signal processing, wherein the hearing devices are connected in a data transmitting manner and wherein the mixing units of the hearing devices are configured for synchronizing the contribution the target audio signal in the respective output audio signals depending on the estimated signal property of the respective input audio signals, in particular depending on a target direction of a sound source. Each hearing device of the hearing system may be configured as described above, in particular each hearing device may comprise an estimation unit. The synchronization of the contribution of the target audio signal ensures that the estimated signal property is not mismatched on both hearing devices. In particular, spatial information contained in the input audio signal may be preserved in the output audio signal, leading to a natural hearing experience. In particular, the synchronization can depend on a target direction of sound source so that spatial information on a position of the sound source is perceivable by the user.

In some examples, an output of the estimation units of the respective hearing devices may be synchronized between the hearing devices. For example, one or both hearing devices may transmit the estimated signal property to the respective other hearing device. This improves the accuracy of the estimation of the signal property and improve synchronization of the contribution of the target audio signal in the respective output audio signals.

As described above, the contribution of the target audio signal in the output audio signal is steered based on an estimated signal property of the input audio signal. This is however not a mandatory feature of the technology described herein described herein. It is also envisaged by the present technology described herein to adapt the contribution of the target audio signal in the output audio signal based on various parameters, e.g. based on one or more of the following parameters: one or more features of an audio acoustic environment, in which the user is in, a listening intention of the user, user inputs and/or other user-specific data, comprising but not limited to user preferences, a position of the user and/or an activity of the user. In general, the contribution of the obtained target audio signal to the output audio signal may be determined upon a provided mixing parameter which may in particular comprise a signal property of the input audio signal and/or one or more of the above-mentioned parameters.

In particular, the following defines an independent aspect of the present technology described herein: A hearing device or hearing system comprising at least one hearing device, wherein the hearing device comprises an input unit for obtaining an input audio signal, a processing unit for processing the input audio signal to obtain an output audio signal, and an output unit for outputting the output audio signal, wherein the processing unit of the at least one hearing device comprises a first audio signal path having a noise cancellation unit for obtaining a target audio signal from the input audio signal, a second audio signal path bypassing the noise cancellation unit, and a mixing unit for mixing the target audio signal from the first audio signal path with audio signals from the second audio signal path for obtaining the output audio signal, wherein the mixing unit is configured to adjust the contribution of the target audio signal to the output audio signal based on a provided mixing parameter. The hearing device and/or hearing system comprising at least one hearing device may include any one of the above-described illustrative aspects of the present technology described herein.

In some examples, the hearing device or the hearing system comprising at least one hearing device comprises a provision unit for providing the mixing parameter, in particular for generating the mixing parameter from other information and/or for receiving the mixing parameter. In some examples, the provision unit may comprise an estimation unit for estimating a signal property of the audio signal to be used in the determination of the mixing parameter, in particular resembling at least part of the mixing parameter.

Additionally or alternatively, the hearing device or hearing system comprising at least one hearing device may comprise a user interface for receiving user inputs to be used in determining the mixing parameter and/or resembling at least a part of the mixing parameter. In some examples, the mixing parameter is at least partially based on user inputs reflecting a user preference with regard to the strength of the noise cancellation. This way, the strength of the noise cancellation can be easily adapted in line with user preferences without requiring to modify the noise cancellation unit, in particular noise cancellation routines performed thereby, for example a neural network for noise cancellation.

Additionally or alternatively, the hearing device or hearing system comprising at least one hearing device may comprise further sensors for obtaining sensor data for being used in the determination of the mixing parameter or resembling at least parts of the mixing parameter.

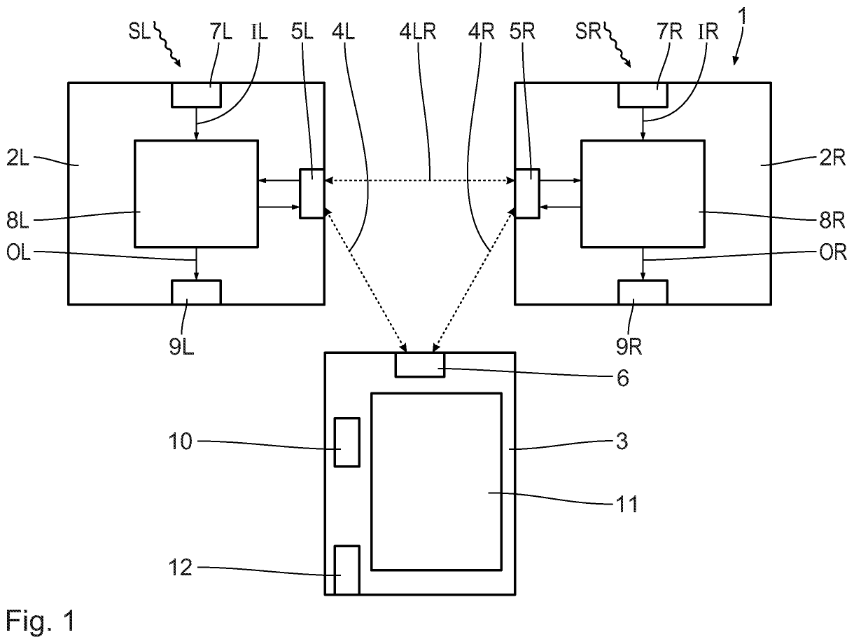

FIG. 1 schematically shows a hearing system 1 associated with a hearing system user (not shown). The hearing system 1 comprises two hearing devices 2L, 2R. The hearing devices 2L, 2R of the shown embodiment are wearable or implantable hearing aids, being associated with the left and right ear of the user, respectively. Here and in the following, the appendix “L” to a reference sign indicates that a respective device, component or signal is associated with or belongs to the left hearing device 2L. The appendix “R” to a reference sign indicates that the respective device, component or signal is associated with or belongs to the right hearing device 2R. In case reference is made to both hearing devices 2L, 2R, their respective components or signals or in case reference is made to either of the hearing devices 2L, 2R, the respective reference sign may be used without an appendix. For example, the hearing devices 2L, 2R may commonly be referred to as the hearing devices 2 for simplicity. Accordingly, the hearing device 2 may refer to any of the hearing devices 2L, 2R.

The hearing system 1 further comprises a peripheral device 3 in form of a smartphone. In other examples, the peripheral device may be provided in form of another portable device, e.g. a mobile device, such as a tablet, smartphone and/or smartwatch. In some embodiments, a peripheral device may comprise a wireless microphone. In some embodiments, two or more peripheral devices may be used.

The hearing devices 2L, 2R are connected to each other in a data transmitting manner via wireless data connection 4LR. The peripheral device 3 may be connected to either of the hearing devices 2L, 2R via respective wireless data connection 4L, 4R. The wireless data connections, in particular the wireless data connection 4LR, may also be referred to as a wireless link. Any suitable protocol can be used for establishing the wireless data connection 4. For example, the wireless data connection 4 may be a Bluetooth connection. For establishing the wireless data connections 4, the hearing devices 2L, 2R each comprise a data interface 5L, 5R. The peripheral device 3 comprises a data interface 6.

The left hearing device 2L comprises an input unit 7L for obtaining an input audio signal IL. The hearing device 2L further comprises a processing unit 8L for audio signal processing. The processing unit 8L receives the input audio signal IL as well as possible further data from the data interface 5L for processing the input audio signal IL to obtain an output audio signal OL. The hearing device 2L further comprises an output unit 9L for outputting the output audio signal OL.

The right hearing device 2R comprises an input unit 7R for obtaining an input audio signal IR. The hearing device 2R further comprises a processing unit 8R for audio signal processing. The processing unit 8R receives the input audio signal IR as well as possible further data from the data interface 5R for processing the input audio signal IR to obtain an output audio signal OR. The hearing device 2R further comprises an output unit 9R for outputting the output audio signal OR.

In the present embodiment, the input units 7 may comprise one or more electroacoustic transducers, especially in the form of one or more microphones. In some examples, each input unit 7 comprises two or more electroacoustic transducers, for example a front microphone and a rear microphone, to obtain spatial information on the respective input audio signal IL, IR. The input unit 7L receives ambient sound SL and provides the input audio signal IL. The input unit 7R receives ambient SR and provides the input audio signal IR. Due to the different positions of the hearing devices 2, the respective ambient sounds SL, SR may differ.

The input units 7 may further comprise (pre-) processing routines for processing the received ambient sounds S into the input audio signal I to be used and processed by the respective processing unit 8. For example, the input unit 7 may comprise a beamformer, in particular a binaural beamformer. The input units may comprise pre-processing routines for applying transformations, such as a Fast Fourier transformation (FFT) and/or a Discreet Cosine Transformation (DCT), window functions, and the like to the received ambient sound S.

An audio signal, in particular the input audio signals IL, IR and the output audio signals OL, OR, may be any electrical signal which carries acoustic information. For example, the input audio signal I may be raw audio data, which is obtained by the respective input unit 7 by receiving the respective ambient sound S. The input audio signals I may further comprise processed audio data, e.g. compressed audio data and/or a spectrum obtained from the ambient sound S. The input audio signals I may contain an omni signal and/or a beamformed audio signal.

The respective processing units 8L, 8R of the hearing devices 2L, 2R are not depicted in detail. The processing units 8 perform audio signal processing to obtain the output audio signal O.

In the present embodiment, the respective output units 9L, 9R comprise an electroacoustic transducer, in particular in form of a receiver. The output units 9 provide a respective output sound to the user of the hearing system, e.g. via a respective receiver. Furthermore, the output units 9 can comprise, in addition to or instead of the receivers, an interface that allows for outputting electric audio signals, e.g., in the form of an audio stream or in the form of an electrical signal that can be used for driving an electrode of a hearing aid implant.

The peripheral device 3 comprises a peripheral computing unit 10. In a particular advantageous embodiment, the peripheral device is a mobile phone, in particular a smartphone. The peripheral device 3 can comprise an executable hearing system software, in particular in form of an app, for providing hearing system functionality to a user. For example, the user can use the peripheral device 3 for monitoring and/or adapting the audio signal processing on the hearing devices 2 using the applicable hearing system software.

The peripheral device 3 comprises a user interface 11, in particular in form of a touchscreen. The user interface can be used for displaying information on the hearing system 1, in particular on the audio signal processing by the hearing devices 2, to the user and/or for receiving user inputs. In particular, the audio signal processing may be adaptable by user inputs via the user interface 11.

Peripheral device 3 further comprises peripheral device sensors 12. Peripheral device sensors 12 may comprise but are not limited to, electroacoustic transducers, in particular one or more microphones, GPS, acceleration, vital parameter sensors and the like. Using peripheral device sensors, user specific data, in particular the position of the user and/or the movement of a user may be obtained.

The above-described hearing system 1 is particularly advantageous. The embodiments described herein are however not limited to such hearing systems. Other exemplary hearing systems may comprise one or more hearing devices. For example, the hearing system may be realized by two hearing devices without need of a peripheral device. Further, it is possible that a hearing system only comprises a single hearing device. It is also envisaged that the hearing system may comprise one or more peripheral devices, in particular different peripheral devices.

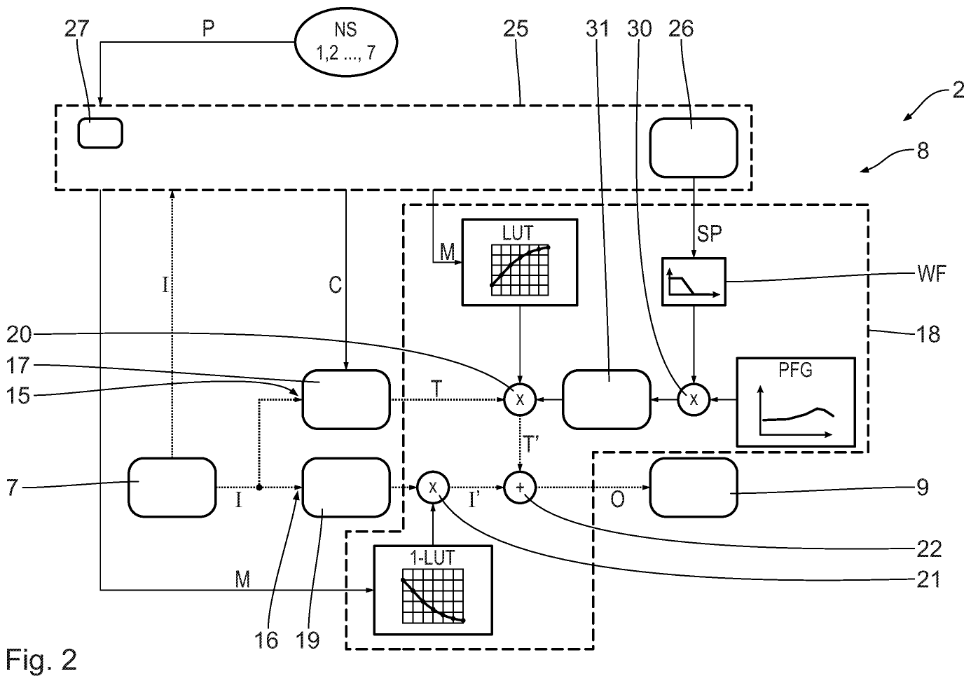

Audio signal processing on either of the hearing devices of the hearing system is exemplarily depicted in FIG. 2. In FIG. 2, the emphasis lies on sequence on processing steps rather than on a structural arrangement of processing units. In FIG. 2, audio signals are depicted by arrows with thick dotted lines and other kinds of signals or data are depicted by narrow-line arrows.

The processing unit 8 of the hearing device 2 comprises two audio signal paths 15, 16. An audio signal path is a processing path in which an audio signal is forwarded and/or processed into another audio signal.

Input audio signal contains a representation of target sound, which are of relevance for the user of the hearing system 1. The representation of the target sound may be referred to as target audio signal T. The target audio signal T may, for example, comprise audio signals representing speech of one or more conversation partners, speech signals of other relevance to the user, e.g. announcements and/or other spoken information like news, music, traffic noise and the like. The target signal is of relevance to the user.

In realistic use cases, the input signal further contains noise, which superimposes the target audio signal T, thereby, for example, decreasing its clarity and/or intelligibility. Audio signal processing on the hearing system 1 has in particular the goal to improve clarity, loudness and/or intelligibility of the target audio signal T to the user.

During audio signal processing, the input unit 7 provides the input audio signal I containing the target audio signal T and noise. The input audio signal I is provided to a first audio signal path 15 and a second audio signal path 16.

The first audio signal path 15 comprises a noise cancellation unit 17 for obtaining the target audio signal T from the input audio signal I. In other words, the noise cancellation unit 17 aims for cancelling the noise from the input audio signal I so that the target audio signal T remains. The noise cancellation unit 17 comprises a deep neural network (DNN) for noise cancellation.

The obtained target audio signal T is provided to a mixing unit 18. The mixing unit 18 is schematically shown by a dashed line surrounding components and functions belonging to or associated with the mixing unit 18.

The second audio signal path 16 bypasses the noise cancellation unit 17. The second audio signal path 16 provides the input audio signal I to the mixing unit 18. The mixing unit 18 serves for mixing the obtained target audio signal T with the input audio signal I, which has not undergone noise cancellation. Mixing the obtained target audio signal T and the unprocessed input audio signal has the advantage that processing artefacts originating from the noise cancellation unit 17, can be reduced. Further, the strength of the noise cancellation can be easily adapted by varying a mixing ratio between the obtained target audio signal T and the un-processed input audio signal I. Influences of the input audio signal on the noise cancellation may be reduced.

The target audio signal T provided to the mixing unit 18 is delayed due to finite processing times for processing the input audio signal I in the noise cancellation unit 17. As such, audio signals in the first audio signal path 15 are delayed with respect to the input audio signal I forwarded in the second audio signal path 16. To compensate for that delay, the second audio signal path 16 passes the input audio signal I through a delay compensation unit 19, compensating for the delay by processing the input audio signal I in the noise cancellation unit 17. Using the delay compensation unit 19, the obtained target audio signal T and the un-processed input audio signal I can be synchronized for being mixed by the mixing unit 18. Doing so, perturbing delays and/or echo effects, which may irritate the user, are reduced, in particular avoided.

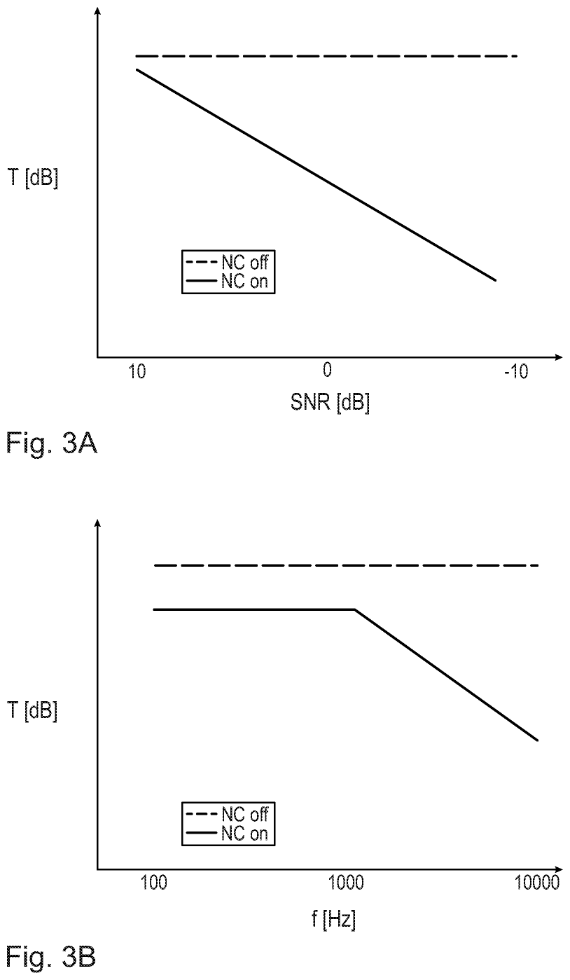

FIGS. 3A and 3B illustrate the influence of the noise cancellation on the target audio signal T in dependence of a signal property SP of the input audio signal. In the illustrated example, the signal property SP is the signal-to-noise ratio (SNR) of the input audio signal I.

FIG. 3A exemplarily illustrates the loss in target audio signal T as a function of the SNR of the input audio signal I. It shows the target audio signal T as a function of the SNR of the input audio signal I, each in decibel. The exemplarily shown dependence of the target audio signal T, may for example be obtained as root mean square (RMS) of target audio signals in different noise scenarios. The figure compares the target audio signal T obtained as part of the input audio signal I without applying noise cancellation (“NC off”, dashed line) with the target audio signal T obtained from the input audio signal I by the DNN of the noise cancellation unit 17 (i.e. with noise cancellation activated, “NC on”, solid line). The target audio signal T strongly decreases with decreasing SNR. This illustrates the strong decrease of the target audio signal T at poor SNRs, impairing the results of noise cancelation. At the same time, noise cancelation is particularly crucial at low SNR. As such, the loss in target audio signal T at low SNR impairs the hearing experience of the user.

In FIG. 3B, an exemplary target audio signal T, obtained as spectrum level, is shown as function of the frequency f. As can be seen, the loss in target audio signal in this example is particularly relevant for higher frequencies, in particular above 103 Hz, e.g. above 2 kHz. In The frequency dependence, in particular the loss in target audio signal T at higher frequencies is irrespective of the processing routine and/or the processing parameters.

The audio signal processing by the processing unit 8 of the hearing device 2 allows for compensating for the influence of varying signal properties SP of the input audio signal I on the target audio signal T, in particular for a loss in target audio signal T. To this end, the obtained target audio signal T is multiplied with a target gain at 20 to obtain a weighted target audio signal T′. At 21, the input audio signal I is multiplied with an input gain to obtain a weighted input audio signal I′. The weighted input audio signal I′ and the weighted target audio signal T′ are combined at 22 to obtain the output audio signal 0, which is passed to the output unit 9. The target gain and the input gain can be adapted as will be described below.

The processing unit 8 comprises a control unit 25 for controlling the audio signal processing in the audio signal paths 15, 16 and/or the mixing of audio signals of the audio signal paths 15, 16. In the present embodiment, the control unit 25 receives the input audio signal I from the input unit 7. In the shown embodiment, the input audio signal is provided in the same format to the control unit 25 as to the audio signal paths 15, 16. In other embodiments, the input audio signal for being processed by the audio signal paths 15, 16 may differ from the input audio signal provided to the control unit. For example, the input audio signal to be processed in the audio signal paths 15, 16 may be a beamformed signal, in particular a binaurally beamformed signal. The input audio signal I provided to the control unit may, for example, be an omni signal.

The control unit 25 may receive processing parameters P. Processing parameters P may, for example, be provided by the peripheral device 3, e.g. via the wireless data connection 4. In an embodiment, processing parameters P are provided by a target fitting, in particular by a hearing care professional. Additionally or alternatively, processing parameters P may contain user input, in particular user input provided via the user interface 11 of the peripheral device 3. For example, the user may adapt the strength of the noise cancellation based on his or her respective preferences. As shown in the exemplary embodiment of FIG. 2, processing parameters P may comprise a noise reduction strength NS chosen by the user. The noise reduction strength may be chosen in steps, e.g., in perceptually equidistant steps. In the shown embodiment, the user may, for example, choose between seven steps for changing the noise reduction strength NS. For example, a slider may be presented to the user on the user interface 11 to set the strength of the noise reduction.

The control unit 25 comprises an estimation unit 26. The estimation unit 26 estimates a signal property SP of the input audio signal I. In the present embodiment, the estimation unit 26 may estimate the SNR of the input audio signal I. In other embodiments, other signal properties SP, in particular a sound level may be estimated by the estimation unit 26. A sound level may comprise one or more approximations of a statistical property in the respective input audio signal I. The sound level may comprise in particular a sound pressure level (SPL), a noise floor estimate (NFE) and/or a low frequency level (LFL). Sound levels, in particular the NFE, may be estimated using less computational resources. At the same time, sound levels may relate to the SNR so that the latter can be approximated by the estimation unit 26 without requiring a direct estimation of the SNR.

The estimation unit 26 averages the signal property SP over a predetermined time span. This ensures smooth adaption of the post-filter gain based on the estimated signal property SP. In the shown example, the estimation unit 26 is configured for averaging the estimated signal property SP over a few seconds, in particular over five seconds. In other embodiments, the predetermined time span may advantageously be varied, e.g. based on the input audio signal I and/or processing parameters P to adapt the steering to the instant situation.

The control unit 25 may further comprise a classification unit 27 for classifying the input audio signal I, in particular for classifying an acoustic scene being related to the input audio signal. Further, the classification unit 27 may take into account further sensor data, e.g. sensor data of the peripheral device sensors 12, for obtaining information on the current acoustic scene and/or the state of the user. Such sensor data may, e.g. be provided together with the processing parameters P.

Based on the classification result of the classification unit 27 and/or a signal property SP obtained by the estimation unit 26, the control unit 25 may provide a control parameter C, selectively activating the noise cancellation unit 17. This way, noise cancellation may be performed when needed, e.g. at poor SNR of the input audio signal and/or when the user is in a loud or noisy surrounding. The following description assumes that the noise cancellation unit is active and provides the target audio signal T to the mixing unit 18.

The mixing unit 18 provides a frequency-dependent post-filter gain PFG for being applied to the obtained target audio signal T as part of the target gain. An exemplary post-filter gain PFG is shown in FIG. 2. The frequency dependence of the post-filter gain PFG is chosen to compensate for the frequency dependent loss in the obtained target audio signal T, as, e.g., shown in FIG. 3B.

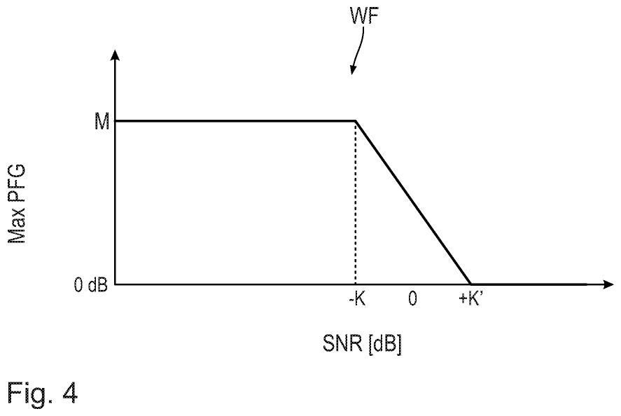

The estimated signal property SP is transmitted from the estimation unit 26 to the mixing unit 18. Based on the signal property SP, in particular based on an estimated SNR, the mixing unit 18 defines a weighting function WF for adapting the post-filter gain PFG, in particular its strength and/or frequency dependence. An exemplary weighting function WF is shown in FIG. 4. The weighting function WF shown in FIG. 4 defines the maximum post-filter gain PFG based on the estimated SNR. At high SNR, where the reduction of the obtained target audio signal T is small or negligible, the post-filter gain may be disabled, by setting its maximum value to 0 dB or, alternatively, by setting the weighting function WF to 0. With lowering SNR, the maximum post-filter gain PFG increases linearly until it reaches its maximum value M. At small SNR, the post-filter gain is applied with its maximum value M. The maximum value M may, e.g. be chosen between 6 dB and 12 dB. Suitable values of the maximum value M may in particular 6 dB or 12 dB. In the shown example, the increase of the maximum post-filter gain is defined symmetrically around 0 dB SNR, reaching from −K to +K′, K and K′ being suitably chosen SNR thresholds. Here, K and K′ are defined positive (K, K′>0) and may be the same (K=K′) or differ (K≠K′). For example, each of K and K′ may be chosen from 5 dB to 10 dB, in particular to about 5 dB or about 10 dB. Of course, the weighting function WF may be differently defined, in particular having a different positioning of the linear increase or even showing non-linear dependencies.

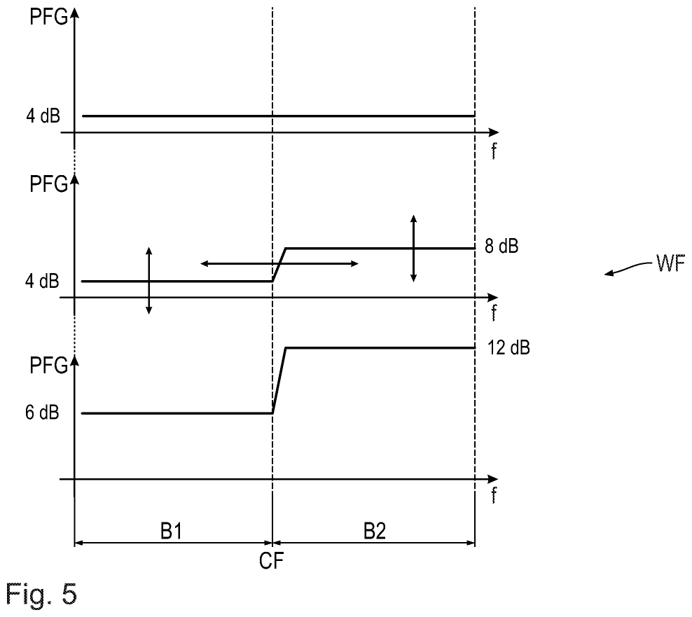

The estimation unit 26 may be configured for determining a frequency dependence of the signal property SP, in particular a frequency dependence of the SNR and/or a sound level. The weighting function WF can adapt the post-filter gain in a plurality of frequency bands in order to compensate for the frequency dependence of the estimate signal property SP. An exemplary frequency dependence of the post-filter gain PFG with a given weighting function WF is shown in FIG. 5. As shown in FIG. 5, the post-filter gain PFG may be independently varied in two frequency bands B1 and B2 separated at a cutoff frequency CF. The strength of the post-filter gain PFG may be individually set in the frequency bands B1, B2, in particular based on the estimated frequency dependence of the signal property SP. For example, FIG. 3B shows that the target audio signal may strongly decrease above about 2 kHz. As such, the strength of the post-filter gain PFG may be chosen to be stronger in the frequency band B2 above a cutoff frequency CF of 2 kHz than in the frequency band B1 below the cutoff frequency CF. It is also possible to change the cutoff frequency CF, e.g. to reflect frequency dependence of the estimated signal property SP. The post-filter gain PFG can be flexibly adapted to the influence of the estimated signal property SP, in particular its frequency dependence, on the target audio signal T. In addition, the PFG may be also adapted to the specific properties of the noise cancelling algorithm or unit. While FIG. 5 shows exemplarily the individual adaption of the post-filter gain PFG in two frequency bands B1, B2, the mixing unit 18 may vary the post-filter gain in an arbitrary number of frequency bands, including but not limited to 2, 3, 4, 5, . . . frequency bands.

The weighting function WF is applied to the post-filter gain PFG at 30, to achieve adaption of the post-filter gain PFG based on the estimated signal property SP. The so adapted post-filter gain PFG is converted by a conversion unit 31 to be applied to the obtained target audio signal T. For example, the strength of the post-filter gain PFG can be defined in decibel for easier handling by the mixing unit 18. For being applied to the obtained target audio signal T, the post-filter gain can be converted into a linear scale by the conversion unit 31. The conversion unit 31 may in particular apply a decibel to linear transformation.

In the shown embodiment, the control unit 25 receives a user-selected noise cancellation strength NS as part of the processing parameters P. The mixing unit is configured for adapting a mixing ratio between the target audio signal T and the input audio signal based on such user-specific data, in particular based on the user inputs. The control unit 25 transmits respective mixing parameters M to the mixing unit 18. Mixing parameters M may be obtained by the control unit 25 based on the processing parameters P, in particular on a provided noise cancellation strength NS, and/or the estimated signal property. The mixing unit 18 is configured to adjust the contribution of the target audio signal T, in particular the mixing ratio, in perceptually equidistant steps. For that, the mixing parameters M are correspondingly converted. In the shown embodiment, the mixing parameters M contain the noise cancellation strength NS, which may be chosen in a plurality of steps by the user. The mixing unit 18 converts the steps of the noise cancellation strength NS in a logarithmic scale to adjust the mixing ratio in perceptually equidistant steps. In the shown embodiment, the mixing unit comprises a look-up table LUT for converting the noise cancellation strength NS into a mixing scale. The obtained mixing scale is applied as part of the target gain to the obtained target audio signal T at 20. The input gain is determined from the mixing parameters M comprising the noise cancellation strength NS by an inverse conversion. In the shown embodiment of FIG. 2, the noise cancellation strength NS is converted by an inverted look-up table 1-LUT for obtaining a mixing scale of the input gain applied to the input audio signal I at 21.

The mixing unit 18 allows to individually enhance the target audio signal T, in particular to enhance its sound level, using target gain, in particular the adaptable post-filter gain PFG. Thereby, an output signal strength of the target audio signal T and the output audio signal O can be easily adapted independently of other audio signals contained in the input audio signal I, in particular independently of noise contained in the input audio signal I. As such, the output signal strength of the target audio signal T in the output audio signal can be adapted by the mixing unit 18 to be equal or higher than an input signal strength of the target audio signal T and the input audio signal I.

Processing parameters P may be used to adapt a mixing ratio of the target audio signal T and the input audio signal I based on user inputs and/or further sensor data, in particular user-specific data. For example, processing parameters P may contain information on the position and/or activity of the user. For example, the mixing ratio may be adapted based on the position of the user. For example, if the user is in a restaurant, the contribution of the target audio signal T in the output audio signal O may be increased to ensure that the user better understands his or her conversation partners. On the other hand, if the user is outside, in particular moving outside, the contribution of the input audio signal I may be increased, ensuring that the user does not miss relevant acoustic information, such as moving cars.

The hearing system 1 comprises two hearing devices 2. In some examples, the hearing devices 2 are adapted for binaural audio signal processing. In a variant, the estimation unit 26 may be configured for estimating, additionally or alternatively to other signal properties, a target direction of a sound source. Based on the target direction of the sound source, the strength of the post-filter gain PFG may be synchronized between the hearing devices 2 in order to maintain spatial information in the respective output audio signal. This may be achieved by applying a corresponding weighting function WF to a respective PFG, wherein the weighting function WF may be synchronized between the hearing devices 2, e.g. by providing the weighting function WF to the hearing devices 2.

In the embodiment of FIG. 2, the control unit 25, in particular the estimation unit 26, is implemented on the hearing devices 2. In other embodiments, the control unit 25 or parts thereof, in particular the estimation unit 26, may be implemented on other devices of the hearing system. For example, it is possible to implement the estimation unit on a peripheral device, for example the peripheral device 3 of FIG. 1. This allows for reducing the computational load on the hearing devices. For example, the signal property SP may be estimated by an estimation unit of the peripheral device and transmitted to the hearing devices 2 via the respective wireless data connections 4. To estimate a signal property SP, the input audio signal I may be transferred from the hearing devices 2 to the peripheral device 3. It is also possible that the peripheral device 3 obtains a peripheral input audio signal, e.g. by one or more microphones of the peripheral device 3, which may be part of the peripheral device sensors 12. Using the peripheral input audio signal is sufficient for estimating relevant properties of the input audio signal I, in particular the SNR or a sound level SL.

In further embodiments, the estimation unit may be part of the noise cancellation unit. In particular, the estimation unit may be incorporated in a deep neural network of the noise cancellation unit. For example, the noise cancellation unit, in particular a deep neural network thereof, may compare properties of the input audio signal and the obtained target audio signal to estimate the respective signal property SP. For example, sound levels of the input audio signal I and the obtained target audio signal T may be compared to estimate the SNR of the input audio signal I.

In further embodiments, the estimation unit, being part of the noise cancellation unit and/or being realized as separate component, may receive the input audio signal I and the obtained target audio signal T to estimate the signal property SP. For example, the SNR may be estimated based on the input audio signal I and the obtained target audio signal T by: SNR=T/(I−T).

What is claimed is:

1. A hearing system, comprising at least one hearing device having:
an input unit for obtaining an input audio signal,
a processing unit for processing the input audio signal to obtain an output audio signal, and
an output unit for outputting the output audio signal,
wherein the hearing system further comprises an estimation unit for estimating a signal property of the input audio signal, and
wherein the processing unit of the at least one hearing device comprises
a first audio signal path having a noise cancellation unit for obtaining a target audio signal from the input audio signal,
a second audio signal path bypassing the noise cancellation unit, and
a mixing unit for mixing the target audio signal from the first audio signal path with audio signals from the second audio signal path for obtaining the output audio signal,
wherein the mixing unit is configured to adjust a contribution of the target audio signal to the output audio signal based on the estimated signal property of the input audio signal.

2. The hearing system according to claim 1, wherein the noise cancellation unit comprises a neural network for contributing to obtaining the target audio signal.

3. The hearing system according to claim 1, wherein the estimation unit is comprised by the at least one hearing device, in particular by the processing unit thereof.

4. The hearing system according to claim 3, wherein the estimation unit is comprised by the noise cancellation unit, in particular by a neural network thereof.

5. The hearing system according to claim 1, wherein the estimation unit is configured for determining at least one of the following signal properties of the input audio signal: a signal-to-noise ratio, a sound level and/or a target direction of a sound source.

6. The hearing system according to claim 1, wherein the estimation unit is configured for determining a frequency dependence of the signal property.

7. The hearing system according to claim 1, wherein the estimation unit is configured for averaging the estimated signal property over a predetermined time span.

8. The hearing system according to claim 1, wherein the mixing unit is configured for applying a post-filter gain, in particular a frequency dependent post-filter gain, to the target audio signal, wherein the post-filter gain depends on the estimated signal property.

9. The hearing system according to claim 8, wherein the mixing unit is configured to adapt the post-filter gain independently in a plurality of frequency bands.

10. The hearing system according to claim 1, wherein the mixing unit is configured to adapt an output signal strength of the target audio signal in the output audio signal to be equal or higher than an input signal strength of the target audio signal in the input audio signal.

11. The hearing system according to claim 1, wherein the mixing unit is configured for further adjusting the contribution of the target audio signal to the output audio signal, in particular a mixing ratio between the target audio signal and an audio signal of the second audio signal path, based on user-specific data, in particular based on user preferences and/or user inputs and/or a position of the user and/or an activity of the user.

12. The hearing system according to claim 1, wherein the mixing unit is configured to adjust the contribution of the target audio signal in the output audio signal in perceptually equidistant steps.

13. The hearing system according to claim 1, wherein the second audio signal path provides the input audio signal to the mixing unit.

14. The hearing system according to claim 1, wherein the second audio signal path comprises a delay compensation unit for compensating processing times in the first audio signal path, in particular processing times by the noise cancellation unit.

15. The hearing system according to claim 1, comprising two hearing devices adapted for binaural audio signal processing,
wherein the hearing devices are connected in a data transmitting manner, and
wherein the mixing units of the hearing devices are configured for synchronizing the contribution of the target audio signal in the respective output audio signals depending on the estimated signal property of the respective input audio signals, in particular depending on a target direction of a sound source.
